(19) United States
(12) Patent Application Publication
(10) Pub. No.: US 2021/0390397 A1
(43) Pub. Date: Dec. 16, 2021

(54) METHOD, MACHINE-READABLE MEDIUM AND SYSTEM TO PARAMETERIZE SEMANTIC CONCEPTS IN A MULTI-DIMENSIONAL VECTOR SPACE AND TO PERFORM CLASSIFICATION, PREDICTIVE, AND OTHER MACHINE LEARNING AND AI ALGORITHMS THEREON

(71) Applicant: Philip Alvelda, VII, Arlington, VA (US)

(72) Inventor: Philip Alvelda, VII, Arlington, VA (US)

(21) Appl. No.: 17/281,174

(22) PCT Filed: Sep. 30, 2019
(86) PCT No.: PCT/US2019/053914

§ 371 Date: Mar. 29, 2021

Related U.S. Application Data
(60) Provisional application No. 62/739,207, filed on Sep. 29, 2018.
(60) Provisional application No. 62/739,208, filed on Sep. 29, 2018.
(60) Provisional application No. 62/739,210, filed on Sep. 29, 2018.
(60) Provisional application No. 62/739,287, filed on Sep. 30, 2018.
(60) Provisional application No. 62/739,297, filed on Sep. 30, 2018.
(60) Provisional application No. 62/739,301, filed on Sep. 30, 2018.
(60) Provisional application No. 62/739,364, filed on Oct. 1, 2018.
(60) Provisional application No. 62/739,864, filed on Oct. 2, 2018.
(60) Provisional application No. 62/739,895, filed on Oct. 2, 2018.

(51) Int. Cl. G06N 3/08; G06K 9/62

(52) U.S. Cl. CPC G06N 3/08; G06K 9/6215; G06K 9/6257

(57) ABSTRACT

A computer-implemented method, computer system and machine readable medium. The method is to implement a training model to be used by a neural network-based computing system to perform distributed computation regarding semantic concepts. A training model corresponding to a data structure to be used by the neural network-based computing system corresponds to a Distributed Knowledge Graph (DKG) defined by a plurality of nodes each representing a respective one of a plurality of semantic concepts that are based at least in part on existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG.

### CROSS REFERENCE TO RELATED APPLICATIONS

This application claims the benefit of and priority from U.S. Provisional Patent Application No. 62/739,207 entitled “Data Representations And Architectures, Systems, And Methods For Multi-Sensory Fusion, Computing, And Cross-Domain Generalization,” filed Sep. 29, 2018; from U.S. Provisional Patent Application No. 62/739,208 entitled “Data representations and architectures for artificial storage of abstract thoughts, emotions, and memories,” filed Sep. 29, 2018; from U.S. Provisional Patent Application No. 62/739,210 entitled “Hardware and software data representations of time, its rate of flow, past, present, and future,” filed Sep. 29, 2018; from U.S. Provisional Patent Application No. 62/739,864, entitled “Machine Learning Systems That Explicitly Encode Coarse Location As Integral With Memory,” filed Oct. 2, 2018; from U.S. Provisional Patent Application No. 62/739,287 entitled “Distributed Meta-Machine Learning Systems, Architectures, And Methods For Distributed Knowledge Graph That Combine Spatial And Temporal Computation,” filed Sep. 30, 2018; from U.S. Provisional Patent Application No. 62/739,895 entitled “Efficient Neural Bus Architectures That Integrate And Synthesize Disparate Sensory Data Types,” filed Oct. 2, 2018; from U.S. Provisional Patent Application No. 62/739,297 entitled “Machine Learning Data Representations, Architectures & Systems That Intrinsically Encode & Represent Benefit, Harm, And Emotion To Optimize Learning,” filed Sep. 30, 2018; from U.S. Provisional Patent Application No. 62/739,301 entitled “Recursive Machine Learning Data Representations, Architectures That Represent & Simulate ‘Self,’ ‘Others’, ‘Society’ To Embody Ethics & Empathy,” filed Sep. 30, 2018; and from U.S. Provisional Patent Application No. 62/739,364 entitled “Hierarchical Machine Learning Architecture, Systems, and Methods that Simulate Rudimentary Consciousness,” filed Oct. 1, 2018, the entire disclosures of which are incorporated herein by reference.

### FIELD

Various embodiments generally relate to the field of machine learning and Artificial Intelligence System, and particularly to the field of building and using knowledge graphs.

### BACKGROUND

Most commercial machine learning and AI systems operate on hard physical sensor data such as data based on images from light intensity falling on photosensitive pixel arrays, videos, Light Detection and Ranging (LIDAR) streams, audio recordings. The data is typically encoded in industry standard binary formats. However, there are no established methods to systematize and encode more abstract, higher level concepts including emotions such as fear or anger. In addition, there are no taxonomies, for naming in digital code format, that can preserve semantic information present in data and how aspects of such information are inter-related.

Prior technologies have relied on general knowledge-graph type data stores that represent both concrete objects and sensory information as well as abstract concepts as a single semantic concept where each node for each semantic concept corresponds to one dimension of the semantic concept. In addition, according to the prior art, semantic concepts defined as respective nodes that are related are typically conceptualized as having a relational link therebetween, forming a typical prior art related concepts architecture and data structure.

However, there are several important limitations to the related concepts architecture described above. First, traditional knowledge graphs scale poorly when broad knowledge domains cover millions of concepts, growing their interconnection densities into an order of trillions or more. Secondly, the computational tools that use algebraic inversions of link matrices to perform simple relational inferences across the knowledge graphs no longer work if there is any link or semantic node complexity, such as probabilistic or dependent node structures. These two factors in concert are the primary reason that classical inference machines that operate on knowledge graphs perform well only on limited problem domains. Once the problem space grows to encompass multiple domains, and the number of concepts grows large, they typically fail.

Another key limitation of the classical knowledge graph data stores is that they have no intrinsic mechanism to handle imprecision, locality, or similarity, other than to just add more semantic concept nodes and more links between them, contributing to the intractability of scaling.

### BRIEF DESCRIPTION OF THE DRAWINGS

Advantages of embodiments may become apparent upon reading the following detailed description and upon reference to the accompanying drawings.

FIG. 1 illustrates a three dimensional graph of a brain including mapped regions thereof, and of associated meta-semantic nodes within a three dimensional graph according to one embodiment;

FIG. 2 illustrates juxtaposed graphs of two distributed knowledge graphs (DKGs) within a 90+ dimensional vector space showing trajectories between nodes within the DKGs according to one embodiment;

FIG. 3 illustrates an energy map in a two-dimensional rendition of a DKG according to one embodiment;

FIG. 4 illustrates a computer system to perform semantic fusion according to one embodiment;

FIG. 5 illustrates a process according to one embodiment;

FIG. 6 illustrates a process according to another embodiment; and

FIG. 7 illustrates an embodiment of an architecture of a system to be used to carry out one or more processes.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

### Overview

Embodiments present novel families of, architectures, data structures, designs, and instantiations of a new type of Distributed Knowledge Graph (DKG) computing engine. The instant disclosure provides a description, among others, of the manners in which data may be represented within a new DKG, and of the manner in which DKG may be used to enable significantly higher performance computing on a broad range of applications, in this way advantageously extending the capabilities of traditional machine learning and AI systems.

A novel feature of embodiments concerns devices, systems, products and method to represent data structures representing broad classes of both concrete object information and sensory information, as well as broad classes of abstract concepts, in the form of digital and analog electronic representations in a synthetic computing architecture, using a computing paradigm closely analogous the manner in which a human brain processes information. In contrast to the “one-node-per-concept dimension” strategy of the state of the art Knowledge Graph (KG) as described above, and as used for example for simple inference and website search applications, new DKG architectures and algorithms are adapted to represent a single concept by associating such concept with a characteristic distributed pattern of levels of activity across a number of Meta-Semantic Nodes (MSNs), such as fixed MSNs. By “fixed,” what is meant here is that once the number of dimensions is chosen, it does not change with the addition of concepts, so that the complexity of the representation does not scale at the order of n\hat{ }2 as one adds concepts, but instead, it scales as Order(n). Accordingly, instead of having one concept dimension per node, in this new paradigm according to embodiments, a concept representation may be distributed across a fixed number of storage elements/fixed set of meta-nodes/fixed set of meta-semantic nodes (MSNs). The same fixed set of MSNs may, according to embodiments, in turn be used to define respective standard format basis vectors to represent respective concepts to be stored as part of the DKG. Therefore, the concept, as embodied in a vector as part of the DKG, may be reflected in different ways based on dimensions chosen to reflect the concept. Each pattern of numbers across the MSNs may be associated with a unique semantic concept (i.e. any information, such as clusters of information, that may be stored in a human brain, including, but not limited to information related to: people, places, things, emotions, space, time, benefit, and harm, etc.). Each pattern of numbers may in addition define and be represented, according to an embodiment, as a vector of parameters, such as numbers, symbols, or functions, where each element of the vector represents the individual level of activity of one of the fixed number of MSNs. In this way, each semantic concept, tagged with its meta-node's representative distributed activity vector (set of parameters that define the semantic concept) can be embedded in a continuous vector space. “Continuous” as used herein is used in the mathematical sense of a continuous function that is smooth and differentiable, as opposed to a discrete, with discontinuities or point like vertices where there is no derivative.

New Capability of Multi-Sensory and Data Modality Fusion

Because, according to some embodiments, any semantic concept may be represented, tagged, and embedded in a continuous vector space of distributed representations involving MSNs, any type of data, even data from widely disparate data types and storage formats, may be represented in a single common framework where cross-data type/cross-modality computation, search, and analysis by a computing system becomes possible. Given that the DKG's modality of concept storage according to embodiments is largely similar to that of the human brain, a DKG according to embodiments advantageously enables the representation of, discrimination between, and unified synthesis of multiple information/data types. Such information/data types may span the range of information/data types, from information/data that is completely physically based, such as, for example, visual, auditory, or other electronic sensor data, to information/data that is completely abstract in its nature, such as data based on thoughts and emotions or written records. Embodiments further advantageously support a tunably broad spectrum of varying gradations of physical/real versus abstract data in between the two extremes of completely physical and completely abstract information/data.

Embodiments advantageously enable any applications that demand or that would benefit from integration, fusion, and synthesis of multi-modal, or multi-sensory data to rely on having, for the first time, a unifying computational framework that can preserve important semantic information across data types. Use cases of such applications include, by way of example only, employing embodiments in the context of diverse healthcare biometric sensors, written medical records, autonomous vehicle navigation that fuses multiple sensors such as LIDAR, video and business logic, to name a few. With greater preservation and utilization of increased information content as applied to computation, inference, regression, etc., such applications would advantageously perform with improved accuracy, would be able to forecast regression farther into the future and with lower error rates.

Advantage in Scalability

In some embodiments, where the basis set of MSNs in a DKG are fixed in number, as new semantic concepts are added to the DKG, the complexity of the DKG as a whole only grows linearly with the number of added semantic concepts, instead of quadratically or even exponentially with the number of inter-node connections as with traditional KGs. Thus, some embodiments advantageously replace the prior art solution of binary connections stored in simple matrices, which solution scales with the square of the number of semantic nodes, with a linear vector tag for each node, which vector tag represents a position of the node representing a given semantic concept in the larger vector space defined by the DKG. Up until embodiments, the prior n\hat{ }2 order of computational scaling properties of traditional KGs has presented a critical limitation in terms of allowing the application of machine learning and AI techniques to only the simplest or most confined problem domains. General questions, or applications requiring the bridging of multiple problem domains, such as ethical and economic questions related to health biometrics and procedures, have, up until now, been computationally intractable using traditional KGs.

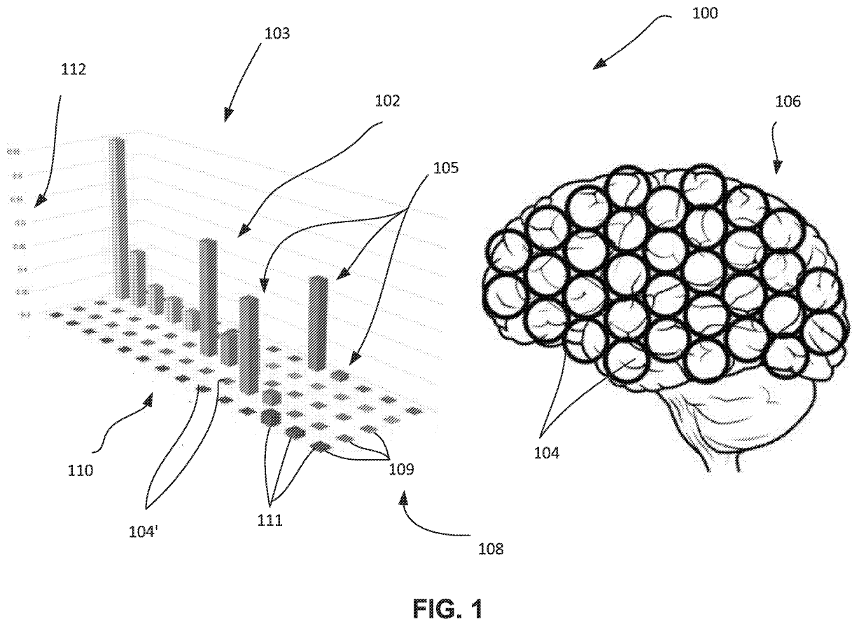

FIG. 1 shows a diagram 100 of a graph 103 and of an associated brain 106 regions of which have been mapped into the graph 103, with each region of the human brain representing broad classes of human experience, and each level of activity in the bar graph representing the amount of activity in the corresponding brain region relative to one single semantic concept In particular, graph 103 depicts activity levels 102 across 70 different partitioned volumes 104 of a brain 106 when the brain is thinking of one particular semantic concept, such as, for example “a tree.” Respective volumes 104 of brain 106 correspond to respective elements 104′ in graph 103, each element as shown corresponding to an intersection of concepts 109 and categories 111 (it is to be noted that lines are directed from the respective reference numerals 109 and 111 to only a few of the shown concepts in the figure) on two respective axes 108, 110, with levels 102 being reflected on a third axis 112 in the figure. Each bar within the bar graph 103 corresponds with a brain activity level 105 at a given element, with each element representing a dimension of the 70 dimensions shown, and each level representing the activity level (the numerical value for that given dimension) for that given element associated with the particular semantic concept: “tree.” In the shown embodiment of FIG. 1, by way of example, concepts on axis 108 may include, for example, respectively, 5 concepts, from bottom to top including feelings, actions, places, people and time, and concepts on axis 110 may include, for example, respectively, 14 categories, from left to right including person, communication, intellectual, social norms, social interaction, governance, settings, unenclosed, shelter, physical impact, change of location, high affective arousal, negative affect valence and emotion. When collected into a vector with seventy elements, this 70 dimensional vector (5 concepts times 12 concepts) may be used according to embodiments to tag the semantic concept, and position the semantic concept within the 70 dimensional vector space of a DKG.

How Semantic Concepts are Tagged & Organized with DKG Vectors

Referring still to FIG. 1, a new synthetic DKG architecture according to embodiments may be built upon a wide range of basis vectors to represent concepts that span human experiences. One particularly powerful instantiation was derived from neuroscience experiments which mapped a multiplicity of small roughly cubic centimeter sized brain volumes, such as volumes 104, partitioned into a set of 60-70 spherical volumes that cover the span of the cortex of the human brain. Each sub-volume of the brain 104, when active, has been found to represent one of a broad class of concepts, such as feelings and emotions, actions, moments in time (refer to axis 108 and concepts 109), as well as broad categories including places in space, physical movements, and even social interactions (refer to axis 110 and categories 111). However, in the aggregate, when all 70 volumes/dimensions resulting from an intersection of concepts and categories are considered, they define complex, varied, and very detailed distinctions with respect to how all of the brain regions may be relatively excited for each individual semantic concept, as well as exemplifying information in the topology of a DKG in terms of the relative activation strengths of simultaneously active meta-nodes, each set of relative activation strengths distinct for individual semantic concepts. Higher order matrices and/or tensors may also be used according to some embodiments to make more topologically complex semantic tags for different positions in the distributed vector space. For example, the array of activity levels for respective semantic concepts as embodied in nodes can be expressed as a 70 dimensional vector or a 5×14 array, as in the example of FIG. 1, and further, in addition to simple scalar variables, complex functions and virtual fields can be superimposed onto the vector space, or be configured to automatically operate on vector space parameters to create additional dimensions and subspaces. Since, in some embodiments, the number of MSNs is static, the field effect computations (i.e. functions) allow scaling in terms of Order(Constant) time to calculate as well: instead of having only arrays of stored vectors populated with numbers, embodiments provide for the imposition of a function that operates over the vector space/domain. For example, if one were to define an energy function in terms of f(x,y) where f(x,y)=x\hat{ }2+y\hat{ }2, the vector space is subjected to a quadratic function centered on the x, y, dimensional zero. According to another embodiment, a dimension in the vector space may be subjected to a function and store the results thereof by taking inputs from values in other dimensions.

Similar Semantic Concepts are Close to Each Other in the DKG Vector Space

A similarity or dissimilarity of semantic concepts according to embodiments is related to their distance with respect to one another as measured within the 70 dimensional space, with similar semantic concepts having a shorter distance with respect to one another.

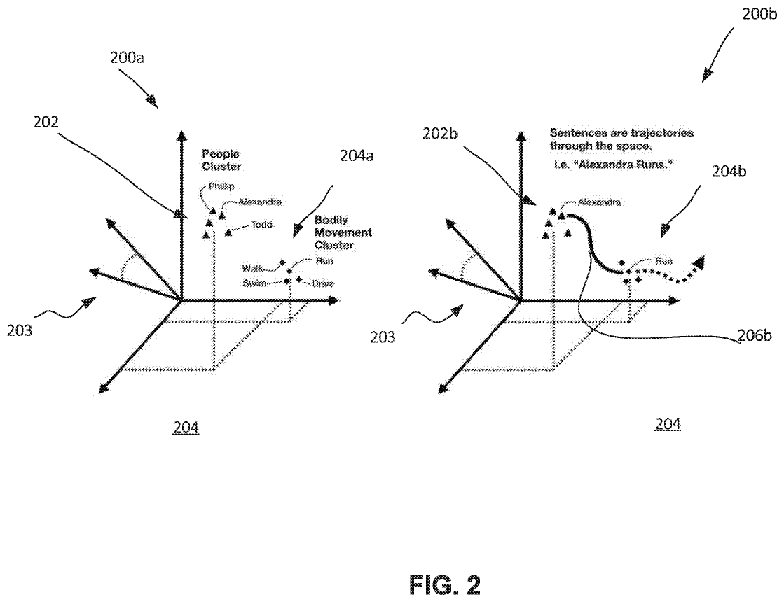

In this regard, reference is made to FIG. 2, which shows a three dimensional projected subspace of a higher (e.g. 90 plus) dimensional vector spaces 200a and 200b with clustered semantic concepts/clusters 202a and 204a for vector space 200a, and 202b and 204b for vector space 200b, where similarity between various semantic concepts may be measured by virtue of their relative proximity. For example, semantic concepts associated with the names Phillip, Alexandra and Todd in FIG. 2 form a cluster 202a and 202b, and semantic concepts associated with physical movement including running, walking, driving and swimming form a cluster 204a and 204b, respectively, in vector spaces 200a and 200b. The dependency of similarity of semantic concepts on distance therebetween in the 70 dimensional space of a DKG according to embodiments and as shown in FIG. 2 is another distinction between embodiments and traditional knowledge graphs, which show similarity simply through connection, typically using a single bit of digital information. However, according to some embodiments, a wide range of distance functions may be used across manifolds and subspaces to further define a degree of similarity/dissimilarity between semantic concepts by embedding substantial complexity with respect to the data based on distance, on manifold shapes and on paths/trajectories between two semantic concepts. As used herein, a “subspace” refers to local volumes of the 70 dimensional vector space that are subsets of the whole space, and that include sub-space manifolds, surfaces, lower dimensional projections and paths/trajectories through the space, and represents collections of similar concepts. Concepts that are more closely related lie closer together in the vector space. The topology of the space and the manifolds represent relationships and dependence between nodes. By “topology,” what is meant herein in the context of a DKG is any one or more defining characteristics of a DKG, such as density, number of dimensions, any information related to any functions superimposed onto the data structure to further modulate the same, etc.). Nodes, regions, and manifolds or subspaces can have attached semantic tags.

In FIG. 2, some of the dimensions of the 90 plus dimensional vector are represented schematically by way of axis arrows 203 which together serve to define the vector space. Each of the axes 203 represent an element on a graph such as graph 103 of FIG. 1, except that graph 103 of FIG. 1 illustrates 70 elements instead of 90+ element.

Referring still to FIG. 2, a DKG according to embodiments may be used to store information not only on semantic concepts, such as “tree” as shown in the graph of FIG. 1, but also on sentences, as suggested in semantic vector space 200b. According to one embodiment, sentences may be represented by trajectories through a semantic vector space. Thus, the sentence “Alexandra runs” may be stored in a DKG according to one embodiment with both MSNs relating to “Alexandra” and “Run,” respectively, tagged with information on trajectory 206b regarding the trajectory from the MSN representing “Alexandra” to the MSN representing “Run” in the semantic vector space.

Subsets of the larger vector space can also be used to focus the data storage and utilization in computation for more limited problem domains, where the dimensions not relevant to a particular problem or class of problems are simply omitted for that application. Therefore, a DKG architecture of embodiments is suitable for a wide range of computational challenges, from limited resource constrained edge devices like watches and mobile phones, all the way through the next generations of AI systems looking to integrate global-scale knowledge stores to approach General Artificial Intelligence (GAI) challenges.

Decomposition of Semantic Concepts into Assemblages of Related Supporting Parameters

An aspect of a DKG Architecture according to embodiments is that, by tagging a semantic concept with its vector in the continuous vector-space, such as the 70 dimensional vector space suggested in FIG. 1, or such as the 90+ dimensional vector space of FIG. 2, the DKG Architecture replaces a simple variable, say a number parameter that describes the level of “happiness” for example, with greatly enhanced information that relates the semantic concept of happiness to all the other semantic concepts that influence it. For example, other semantic concepts that are closer to, and influence “happiness,” such as the semantic concept of particular people's names, will be closer in the vector space to the happiness semantic concept than those less emotionally appealing. The above feature affords significantly enhanced information across the stored knowledge graphs above and beyond the existing solutions on simple parameters.

Representing Complex Abstract Anthropomorphic Semantic Concepts

In traditional knowledge graphs, the single concept dimension per node representation fails to capture critical nuances and detail of what influenced or was related to, or even what composed a semantic foundation for any one abstraction including but not limited to: emotions, good/bad, harm/benefit, fear, friend, enemy, concern, reward, religion, self, other, society, etc. However, with a DKG, according to embodiments, much more of the relational and foundational complexity is intrinsically stored with a semantic node by virtue of its position in the continuous vector space which represents its relation to the 70 different MSN concepts that form the basis of that space, as well as, notably, by virtue of distance as evaluated with respect to nearby concepts, and by virtue of how the semantic nodes are interconnected by both the local manifolds and the dynamics of the temporal memories that link nodes in likely trajectories. With this enhanced information intrinsic to the new knowledge store, synthetic computations on difficult abstractions may much more closely approach human behavior and performance.

Representing Physical Space in the DKG

The DKG according to embodiments is also a perfect storage mechanism to reflect how spatial information is stored in the human brain to allow human-like spatial navigation and control capabilities in synthetic software and robotic systems. If an application demands spatial computation, additional dimensions may be added to the continuous vector space for each necessary spatial degree of freedom, so that every semantic concept or sensor reading is positioned in the space according to where in space that measurement was encountered. A range of coding strategies are possible and can be tuned to suit specific applications, such as applications involving linear scaled latitude and longitude and altitude for navigation, or building coordinate codes for hospital sensor readings, or allocentric polar coordinates for local autonomous robotic or vehicle control and grasping or operation.

Explicitly Representing Time in the Distributed Knowledge Graph

Traditional neural network architectures represent time as having been engineered out of static network representations that analyze system states in discrete clocked moments of time, or in the case of recurrent or Long Short-term Memory (LSTM) type networks, embed time as implicit in the functional dynamics of how one state evolves following the dynamical equations from one current state to a subsequent one. In contrast to those traditional neural computation strategies which treat time as either engineered-away, or implicit in the memory dynamics, new DKG architectures, according to embodiments, allow for the explicit recording of a time of receipt and recording of a concept or bit of information, again, simply by adding additional dimensions for a time stamp to the continuous vector space. Again, a wide range of coding strategies are possible, from linear lunar calendar, to event tagged systems. Linear and log scales, and even non-uniform time scales which compress regions in a time domain of sparse storage activity and apply higher dynamic ranges to intervals of frequent data logging are possible according to embodiments. Cyclical time recording dimensions may, according to some embodiments, also be used to capture regular periodic behavior, such as daily, weekly, annual calendar timing, or other important application-specific periodicity. The addition of temporal information tags for stored data element offers an additional dimension of data useful for separating closely clustered information in the vector space. By analogy, people are better at recognizing faces in the places and at the typical times where they have seen those faces before.

Latent Dimensions, Renormalization, and Other Newly Accessible Numerical Tools

Because the vector space representation of the DKG is continuous, a wide range of tools from physical science may be applied therein in order to allow a further honing of the representation and analysis of, and computation of semantic concepts. For example, the data may even include data relating to general knowledge and/or abstract concept analysis. According to embodiments, operations widely used according to the prior art to tease out details and nuances from complex data, using with unwary directed binary links (which operations may be necessary in the context of a one-node-per context framework) are obviated. Embodiments advantageously apply varying types, ranges and amounts of data to DKGs. A tool according to embodiments is the ability to renormalize/reconfigure regions of a vector space to better separate/discriminate between densely related concepts, or to compress/condense sparse regions of the vector space. Another tool is based in the ability to add extra latent dimensions to the space (such as “energy” or for “trajectory density” to add degrees of freedom that would enhance distinct signal separability. By “energy,” what is meant herein is a designation of a frequency of traversal of a given dimension, such as a trajectory, time, space, amount of change, latent ability for computational work, etc., as the vector space is being built. Beyond the above tools, for the most part, all of the tools of physics and statistics may be directly applied to general knowledge formerly trapped by limited discrete representations.

Mechanism #1 for Short-Term Temporal Dynamics & Learning: Local Fields and Energy Dimensions

Additional dimensions may be added to the vector space according to embodiments to track additional parameters useful for learning, storage, efficient operation, or improvement in accuracy. Reference is again made to FIG. 2. According to some embodiments, sequences of thoughts and actions (such as spoken or heard sentences, or sequences of images and other data from autonomous vehicle sensors) that describe or operate on objects or concepts are represented computationally as trajectories of thought or sentences, and traverse the manifold from one concept to another, such as, for example, as represented by trajectory 206b. The paths of sequences of words in thought or speech may be tracked and logged according to some embodiments over vast volumes of experience and data recording. As with traditional machine learning technology, vast data sets including, but not limited to written text, spoken words, video images and data from car sensors, electronic health records of all data types, can all be presented to, and stored within a DKG according to some embodiments.

The learning process according to embodiments may use any of a broad class of algorithms which parameterize, store and adaptively learn from information on the trajectory of each semantic concept, including information of how and in which order in time each semantic concept is read in the context of each word and each sentence (for example, each image in a video may be presented in turn), to create a historical record of traffic, which historical record of traffic traces paths through the vector space that, trip over trip, describes a cumulative map, almost like leaving bread crumbs in the manner of spelunkers who track their escape from a cave. The result is that with every extra sentence or video sequence trajectory, another layer of digital crumbs (or consider it accumulated potential energy, to be relatable to gradient descent algorithms in physics and machine learning) is stored/left behind to slowly accumulate as learning progresses with every trial.

Learning algorithms that may be used in the context of a DKG according to embodiments may include, for example, supervised learning, unsupervised learning, semi-supervised learning, reinforcement learning, transfer learning, generative learning, dynamic learning, to name a few. Learning algorithms according to embodiments, at least because they operate on a DKG that is continuous, advantageously allow an improvement of training speed by virtue of allowing/making possible a convergence of learning data into a single architecture, allow a reduction of training speed by virtue of the convergence, and further make possible novel training objectives that integrate data from different data domains into one or more integrated superdomains that include an integration of two or more domains. Embodiments provide a fundamentally novel training architecture for training models, one that is apt to be used for training in a myriad of different domains.

The above algorithm results in a potential map across the vector space, on which any gradient descent or field mapping, and trajectory analysis software can be applied to generate least time, minimum energy type paths, as well as most likely next steps in a trajectory (or even generate an ordered set of most likely next semantic concepts on the current path.).

After a learning epoch, the overall dimensions for energy in a vector space can be visualized as an accumulated surface level of “energy” where the least-to-most likely paths through the space between two semantic concepts appear as troughs and valleys, respectively. These surfaces can be processed/interpreted/analyzed using any typical field mapping and path planning algorithm (such as, by way of example only, gradient descent, resistive or diffusive network analysis, exhaustive search, or Deep Learning), to discover a broad range of computationally useful information including information to help answer the following questions:
1. What is the most efficient and shortest path to relate to respective ones of different concepts?
2. What other semantic concepts might be near a current/considered path, and information-equivalent? i.e. solving the similarity problem in a scalable way.
3. How dense/important are the trajectories through a particular semantic concept?
4. After traversing the DKG in a trajectory through training sets of example specific semantic concepts, given the current trajectory, what are the most likely next concepts, or sensor readings, or experiences to expect?
5. Given a current state/location and velocity in the DKG vector space, what were the most likely antecedents to the current state? By “velocity,” what is meant is the speed at which a trajectory traverses the vector space in moving from one input of a semantic concept to the next. Given that the vector space corresponds to a continuous space, one can measure position, and change in position in dimension x, and with time, one can then calculate dx/dt=velocity.

Sample Energy Field Based Learning and Operation Algorithm

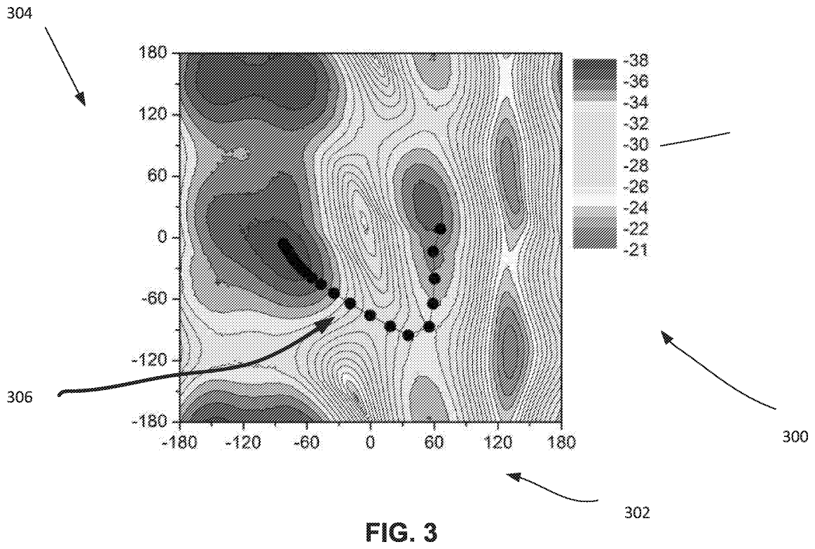

Reference is now made to FIG. 3, which shows a graph 300 of a sample energy field for semantic concepts and trajectories according to some embodiments. In FIG. 3, the horizontal and vertical axes 302 and 304 depict two dimensions in a multidimensional DKG vector space. In the shown 2D rendition of the DKG, the darker regions correspond to the various nodes represented in the DKG by way of respective vectors. Graph 300 may be generated according to one embodiment by using the below in order to generate the energy field, which may be established by achieving training based on the sets of semantic concepts:
1. for every string of semantic concepts in a sentence or in a sequence of sensory experiences to be recorded:
   1. for the first semantic concept in the string to be ingested into the knowledge graph, assign its proper multivector (such as 70-vector) tag as defined in an MRI experimental measures, which tag is a measure of the various levels of response for that particular semantic concept at respective elements/dimensions of the multivector space, such as levels 102 of FIG. 1 in graph 103. Thereafter, add one unit of energy to the local energy field variable (local to the MSN representing the semantic concept) at the region of the vector space. Note that the radius over which a parameter value, such as energy, is added to a given field of that parameter value may be tuned according to some embodiments;
   2. for each subsequent semantic concept that has been read and vector tagged as explained in 1. above, compute a line/trajectory, such as line/trajectory 306, from the prior semantic concept in the string to the current one, and distribute/assign one unit of energy along the path of that line/trajectory; and
   3. repeat for each semantic concept in the sentence or experience string; and
2. repeat for every sentence or experience string.

An operation according to some embodiments may include:
3. supplying an initial or an incomplete string (with string referring to a string of semantic concepts of a vector space, the semantic concepts in a sentence or in any another format to form the string);
4. using a gradient ascent mechanism to perform a regression forward in time to estimate a most likely next point/node corresponding to one or more first semantic concepts in the vector space;
5. using a gradient ascent backward in time to estimate most likely antecedent point/node corresponding to one or more second semantic concepts in the vector space;
6. using relaxation methods on the surface, such as, for example, Hopfield, diffusion, recurrent estimation, or the like for any incomplete strings to complete missing points. For example, using the concept of the Hoppfield associative memory, the observation of an image through fog may lead to a decision that the image corresponds to head and fog lights, without more information. The relaxation method takes the existing input, and uses the intrinsic dynamics of how the inputs nodes/points are all interconnected to one another (the connections of which have been programmed through repeated exposure to complete cars) to iteratively fill in the missing data to lead to a decision that the image corresponds to a car that would go with that set of imaged headlights, completing the picture, the missing point.
7. using relaxation methods in numerical mathematics to propagate an initial activity of two distinct points/nodes across the energy surface to determine shortest path/trajectory between the two distinct points/nodes, accumulated energy (i.e. or how close is the relationship) between two semantic concept nodes in the vector space; and/or
8. inputting multiple semantic data outputs from a prior stage of neural networks into the DKG to synthesize them and couple them with additional semantic data and written and other business logic to perform and optimize sensory fusion.

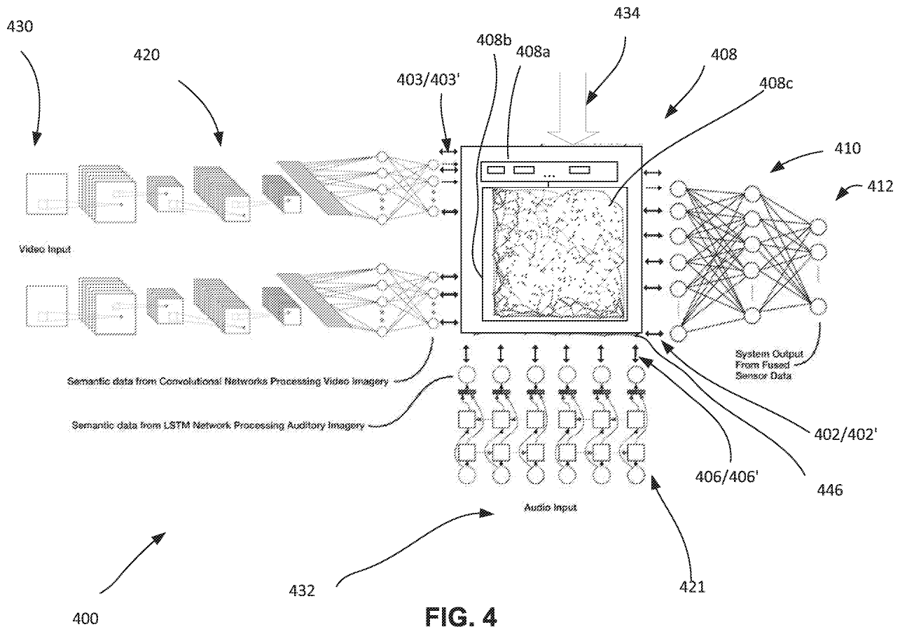

With respect to item 8 immediately above, reference is now made to FIG. 4, which depicts a system 400 including a computer system 408 including one or more processors 408a and a memory 408b, the computer system 408 to receive various types of data inputs for synthesis of various data types therein. Memory 408b is to store a DKG according to some embodiments. Computer system 408 is adapted to perform a set of parameterizations of semantic concepts, and generate a training model from those concepts, the training model corresponding to a data structure associated with a DKG according to some embodiments. In the shown embodiment of FIG. 4, the semantic concepts correspond to semantic data 403 from neural network-based computing system 420 that are to process video imagery, and further to semantic data 406 from neural network-based computing system 421 that are to process audio data.

Neural networks to be used for leaning and for making predictive analysis on the training model generated from the learning according to embodiments may include any neural networks, such as, for example convolutional neural networks or recurrent neural networks to name a few. The neural network-based computing systems 420 and 421 of FIG. 4 respectively receive video data 430 and audio data 432 as inputs thereto for training and subsequent computation/processing/analysis.

According to an embodiment, each parameterization of the set includes: (1) receiving existing data representing semantic concepts (where, in the shown example of FIG. 4, the existing data corresponds to empirical data 434 and to video data 403 from an output of a neural network-based computing system 420 that processes video input, and of audio data 406 from an output of a neural network-based computing system 421 that processes audio input); (2) generating a data structure using the processing circuitry, the data structure corresponding to a Distributed Knowledge Graph (DKG) defined by a plurality of nodes each representing a respective one of a plurality of unique semantic concepts (in the shown case of FIG. 4, for example, semantic concepts corresponding to both video data and audio data, including a fusion of both types of data from respective data domains (e.g. video and audio)—that is, a combination of the dimensions associated with each type of data to define respective nodes in the DKG), the plurality of unique semantic concepts being based at least in part on the existing data (that is, for example, on data 434, 403 and 406), each of the nodes represented by a characteristic distributed pattern of activity levels for respective meta-semantic nodes (MSNs) (as shown for example in FIG. 1), the MSNs for said each of the nodes defining a standard basis vector to designate a semantic concept, wherein standard basis vectors for respective ones of the nodes together define a continuous vector space of the DKG; and (3) storing the data structure in the memory circuitry of computer system 408. In addition, according to some embodiments, in response to a determination that an error rate from a processing of the data set by the neural network-based computing system is above a predetermined threshold (where a determination of a predetermined threshold according to embodiments is implementation based/based on application needs, with a lower threshold corresponding to instances where making an error would carry a higher degree of risk, such as, for example, errors associated with processing/interpreting/analyzing certain medical data), an embodiment includes performing a subsequent parameterization of the set. A repetition of the parameterization stage may involve, according to some embodiments, an outputting of data back into each of the neural network-based computing systems 420 and 421 from computer system 408 in order for those networks to perform learning algorithms on the thus outputted data before re-inputting the data, as existing data, back into the computing system 408 for further parameterization. An embodiment includes generating a training model corresponding to the data structure from a last one of the set of parameterizations, the training model to be used by the neural network, such as neural network-based computing systems 420 and 421, to process/perform a computational algorithm on/interpret/analyze semantic data, such as, for example, by performing predictive analytics on a data set, performing classification based on the data set, or performing any other type of computation on the data set, to name a few examples. According to one embodiment, computer system may be deemed to include the neural networks 420/421.

As referred to herein, “input” and “output” in the context of system hardware designate one or more input and output interfaces, and “input data” and “output data” in the context of data designate data to be fed into a system by way of its input or accessed from a system by way of its output.

Video data inputs 403 may be generated by neural networks 404 adapted to process video imagery 420, such as, for example, in a known manner. Audio data inputs 406 may be generated by neural network 421 adapted to process auditory information, such as, for example, in a known manner. Data from the DKG memory store 408 is shown as being outputted at 402 into a neural network-based computing system 410. Neural network-based computing systems 420, 421 and 410 may, according to some embodiments, function in parallel to provide predictions regarding different dimensions or clusters of dimensions of the data stored within the DKG of computer system 408.

Where DKG represents a distributed knowledge store of nodes represented by multidimensional vectors, such as in the shown example of FIG. 4 by vectors that synthesize at least video and audio information, a DKG according embodiments advantageously permits: (1) more meaningful learning to take place within respective neural network-based computing systems by virtue of more meaningful data sets from the DKG memory store, and (2) data output from a neural network, such as neural network-based computing system 410, that operates based on fused/converged data, with all of the advantages with respect to the use of such data, such as, for example: (a) much faster processing time by virtue of the ability to access and use multiple dimensions of data for a given node simultaneously to operate neural network-based computing systems in parallel (such as neural network-based computing systems 420 and 421 of FIG. 4) with one another to process respective types of data, such as respective dimensions of data simultaneously; and (b) as noted previously, the ability to afford a linear scaling with respect to data storage complexity as opposed to the quadratic or even exponential scaling expected with the one concept dimension per node approach of the prior art to advantageously allow a more efficient use of computer memory space, allowing a given memory space to be used to store more data and more relationships between the data than a given memory space to be used to store data structures of the prior art to be used in neural networks and (c) the ability to afford a linear scaling with respect to data storage complexity as opposed to the quadratic or even exponential scaling expected with the one concept dimension per node approach of the prior art to advantageously allow the use of computational tools configured to implement and process multi-dimensional data, in this manner speeding up the implementing of data structures for training models to be used by neural network-based computing systems for interpretation/processing, such as for performing predictive analytics, for classification, or for other computations, and in this way also leading to the accuracy and automation of data processing where, instead of a manual process of integrating data from different domains, integrated data from various domains can be accessed by respective neural networks in parallel and learning with respect to such integrated data may take place by way of machine learning instead of requiring human interference to integrate output data of the respective neural network-based computing systems such as for processing/interpreting data sets.

An embodiment to fuse data, as shown by way of example in FIG. 4, advantageously allows the implementation of higher level neural network systems that are effectively integrations of respective neural network-based computing systems, with modular systems of neural network-based computing systems that are specialized to specific computational tasks unique to their individual sensor modality and data types, and yet, all are synthesized through the central switching station represented by the DKG.

Mechanism #2 for Long-Term and Higher-Order Temporal Dynamics & Learning: A Cerebellar Predictive Co-Processor

Embodiments relating to the local field learning mechanism above are suitable for helping to navigate through the vector space and compute with nearby similar semantic concepts that are neighbors within a vector space at a close range, with the definition of close being implementation specific. To navigate larger jumps and perform meaningful computations between more disparate concepts that are more distant across the vector space (again, with the definition of distant being implementation specific), some embodiments provide mechanisms that incorporate more global connections between semantic nodes to manage larger leaps and transitions in logic as well as the combination of a wide range of differing data types and concepts.

To be useful in the real world however, embodiments may also rely on an intrinsic notion of time, embodied as data, that can reference and include past learned experience, understand its current state, and use both learned information about stored past states combined with sensor derived information on the system's current state to predict and anticipate future states.

Combining these two fundamental requirements of a DKG incorporating information on the intrinsic notion of time into the specification for a synthetic system makes it possible to recapitulate the functioning of the human cerebellum. A Synthetic Predictive Co-processor (SPC) according to embodiments, like the human cerebellum, is connected to the entirety of the rest of its cortex, in the synthetic case, to each of the nodes of the DKG, through which connections it monitors processing throughout the brain, and generates predictions as to what state each part of the brain is expected to be in across a range of future time-scales, and supplies those global predictions as additional inputs for the DKG. As with the human brain, the addition of expectation, or in the synthetic system, having a prior and posterior probability prediction together improve system performance.

In a sense then, the cerebellar SPC becomes a high volume store of sequences or trajectories through the vector space, which can track multiple hops between distant concepts that are unrelated other than that they are presented through a sentence or string of experiences. Average sentences require 2-5 concepts, so predictive coprocessors focusing on natural language processing can be scoped to store and record field effects across the vector space for 5-step sequences. Longer sequences, such as chains of medical records, vital signs, and test measurement results will require longer sequence memories.

Another instantiation of the SPC according to some embodiments may be based on Markov type models, but extended from the discrete space of transition probabilities to the continuous vector space of trajectories within a DKG, given prior points in the trajectory. Different applications may require different order predicates, or number of prior points according to some embodiments. The larger the number of predicate points, the higher the storage requirements are, and the greater the diversity of predictive information.

The above new architectural approach has the added feature that continuous mathematical tools can be applied to the vector space tags, and discrete graph tools can be applied to the semantic nodes to determine typical graph statistics (degree/property histogram, vertex correlations, average shortest distance, etc.), centrality measures, standard topological algorithms (isomorphism, minimum spanning tree, connected components, dominator tree, maximum flow, etc.)

The Central Integration Component to Build More Complete Brains

For a synthetic system, we can replicate the end-to-end capability according to some embodiments for the most part in any machine learning architecture, leveraging the fact that the DKG lies on a continuous vector space domain, and several key parameters lie as continuous functions on the space, such as the energy and error surfaces, and are therefore differentiable. This means that for the first time, all of the gradient descent (such as Backwards Error Propagation) learning strategies, and all the dynamical systems based relaxation techniques, such as Hopfield and recurrent type networks, to tune weights and connectivities, and parameters of networked computing elements, as in Deep Learning, and neural network-based computing systems, can be applied to knowledge graph learning and tuning. This foundational capability was not possible with traditional knowledge graphs based on discrete nodes with digital connections, where there was no gradient or surface function that was differentiator in order to determine error calculations. Neural training processes and systems of the prior art were therefore confined to operations on respective isolated single-modality subsystems, and could not operate on a whole larger integrated meta-network composed of different sensory modality processing subsystems, such as, for example, neural network-based computing systems 420, 421 and 410 of FIG. 4, necessary to fuse multiple input data types or data domains and learn from and through them.

Because the DKG may, according to an embodiment, have the same properties of continuity and differentiability as Deep Learning and Neural network-based computing systems, such as Convolutional Networks, for the first time, any type of neural architecture can be seamlessly integrated together with a DKG, and errors and training signals propagated throughout the hierarchical assemblage.

In this sense, the DKG becomes the coupling mechanism by which previously incompatible neural network type computing engines can all be interconnected to synthesize broader information contexts across multiple application domains. They becomes the central point of integration, a larger network of neural network-based computing systems to make more complete synthetic brains capable of multi-sensory fusion and inference across broader and more complex domains than was ever possible before with artificial systems.

Information Encoding Strategies

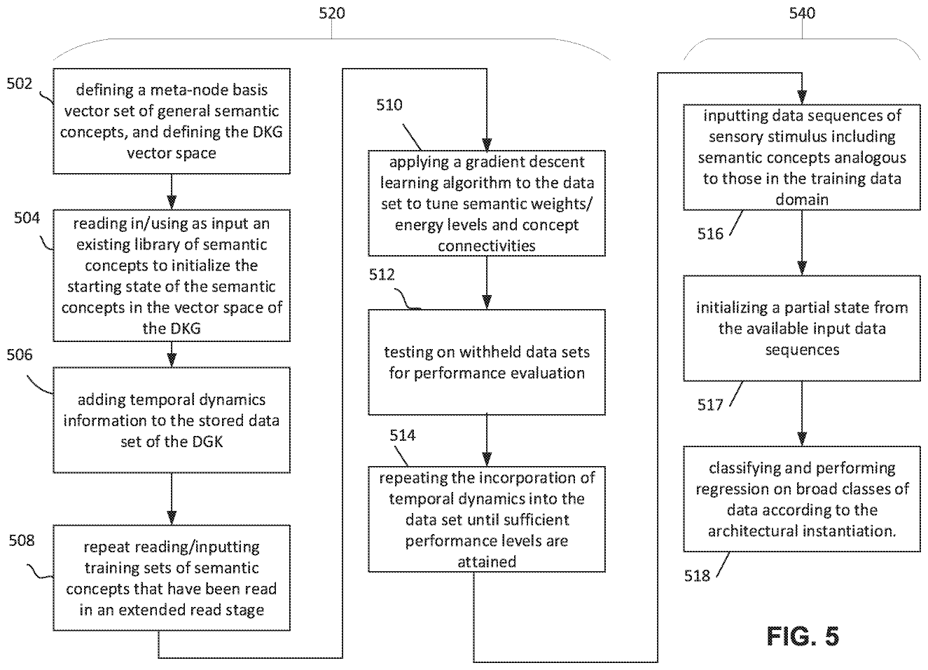

Principles of operation of some embodiments are provided below, reflecting some embodiments of information encoding strategies, as illustrated by way of example in FIG. 5. The process 500 of FIG. 5 may include an initialization and learning/training stage 520, and a generation operation stage 540.

Initialization and learning stage 520 may first include at operation 502, defining a meta-node basis vector set of general semantic concepts, and defining the DKG vector space based on the same. In this respect, reference is made to the 70 dimensional vector space suggested in FIG. 1, and the 90+ dimensional vector space of FIG. 2, which help to store vector tags to identify distinct semantic concepts. Thereafter, at operation 504, the initialization and learning stage 520 may include reading in/using as input an existing library of semantic concepts to initialize the starting state of the semantic concepts to position them in the vector space of the DKG. A strategy according to an embodiment may involve using one of the human spoken words+ Functional Magnetic Resonance Imaging (FMRI) databases, where each word spoken to a subject can be tagged with the associated activity vector indicated by the brain FMRI readings. Different verbal corpora can be used to make semantic maps in the DKG for different application areas according to some embodiments. At operation 506, temporal dynamics information may be added to the stored information in the DGK, either after the reading/input stage noted above, or in parallel therewith. In the case of the latter, as once reads successive semantic concepts to be added to the DKG, it is possible to add the path tracking information or “breadcrumbs” to log most traveled/likely semantic trajectories through the vector space of the DKG. Other strategies to record and include temporal dynamics according to some embodiments may include: using Bayesian or Markov model type algorithms that encode and exploit probabilities of state changes, and/or training neural architectures that encode temporal dynamics on the vector space, such as recurrent neural network-based computing systems or LSTMs. Thereafter, at operation 508, training sets of semantic concepts that have been read in are repeated in an extended read stage. In the process of training, sets of sequences of semantic concepts in the logical flow of an application may be repeated so that the system is trained over time to learn the most common sequences. After the repetition, a initialization and learning stage 520 according to some embodiments includes at operation 510 applying a gradient descent learning algorithm to tune semantic weights/energy levels and concept connectivities. Several applicable algorithms that are compatible with this new architecture include: a Naïve Bayes Classifier Algorithm, a K Means Clustering Algorithm, a Support Vector Machine Algorithm, an Apriori Algorithm, Linear Regression, Logistic Regression, Artificial Neural network-based computing systems, Random Forests, Decision Trees, Nearest Neighbors. According to an embodiment, the initialization and learning stage 520 may involve at operation 512 testing on withheld data sets for performance evaluation. According to an embodiment, a initialization and learning stage 520 may further include at operation 514 repeating the incorporation of temporal dynamics into the data set until sufficient performance levels are attained.

Referring still to FIG. 5, the generation operation stage 540, which begins after the initialization and training stage 520, includes at operation 516, inputting data sequences of sensory stimulus including semantic concepts analogous to those in the training data domain. At operation 517, stage 540 includes initializing a partial state from the available input data sequences, and at operation 518, stage 540 includes classifying and performing regression on broad classes of data according to the architectural instantiation.

Specific examples of particular instantiations and applications are provided below.

Embodiments may be used in the context of improved natural language processing. The latest NLP systems vectorize speech at the word and phoneme level as the atomic component from which the vectors and relational embedding and inference engines operate on to extract and encode grammars. However, the latter represent auditory elements, not elements that contain semantic information about the meaning of words. By using the DKG space, the atomic components of any single word are the individual MSN activity levels representing the all compositional meanings of the word, which in the aggregate hold massively more information about a concept than any phoneme. Deep Learning and LSTM type models may therefore be immediately enhanced in their ability to discriminate classes of objects, improve error rates and forward prediction in regression problems, and operate on larger and more complex, and even multiple data domains seamlessly, all enabled if the data storage and representation system were converted to the continuous vector space of the DKG architecture according to embodiments.

Embodiments may be used in the context of healthcare record data fusion for diagnostics, predictive analytics, and treatment planning. Modern electronic health records contain a wealth of data in text, image (X-ray, MRI, CAT-Scan) ECG, EEG, Sonograms, written records, DNA assays, blood tests, etc., each of which encodes information in different formats. Multiple solutions, each of which can individually reveal semantic information from single modalities, like a deep learning network that can diagnose flu from chest x-ray images, can be integrated directly with the DKG into a single unified system that makes the best use of all the collected data.

Embodiments may be used in the context of multi-factor individual identification and authentication which seamlessly integrates biometric vital sign sensing with facial recognition and voice print speech analysis. Such use cases may afford much higher security than any separate systems.

Embodiments may be used in the context of autonomous driving systems that can better synthesize all the disparate sensor readings. Including LIDAR, visual sensors, onboard and remote telematics.

Embodiments may be used in the context of educational and training systems that integrate student performance and error information as well as disparate lesson content relations and connectivity to generate optimal learning paths and content discovery.

Embodiments may be used in the context of smart City infrastructure optimization, planning, and operation systems that integrate and synthesize broad classes of city sensor information on traffic, moving vehicle, pedestrian and bike trajectory tracking and estimation to enhance vehicle autonomy and safety.

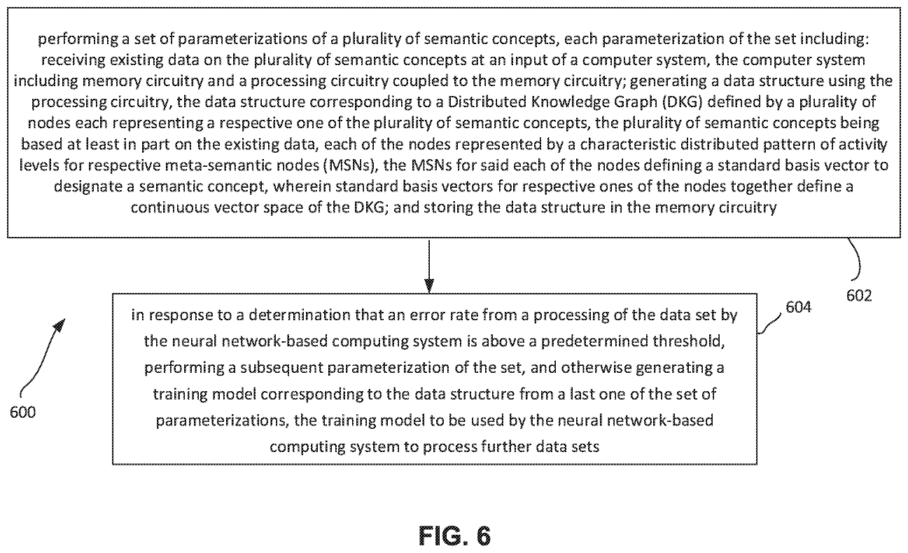

FIG. 6 shows a process 600 according to an embodiment. Process 600 includes, at operation 602, performing a set of parameterizations of the plurality of semantic concepts, each parameterization of the set including: receiving existing data on the plurality of semantic concepts at an input of a computer system, the computer system including memory circuitry and a processing circuitry coupled to the memory circuitry; generating a data structure using the processing circuitry, the data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and storing the data structure in the memory circuitry; and at operation 604; and at operation 604, in response to a determination that an error rate from a processing of the data set by the neural network-based computing system is above a predetermined threshold, performing a subsequent parameterization of the set, and otherwise generating a training model corresponding to the data structure from a last one of the set of parameterizations, the training model to be used by the neural network-based computing system to process further data sets

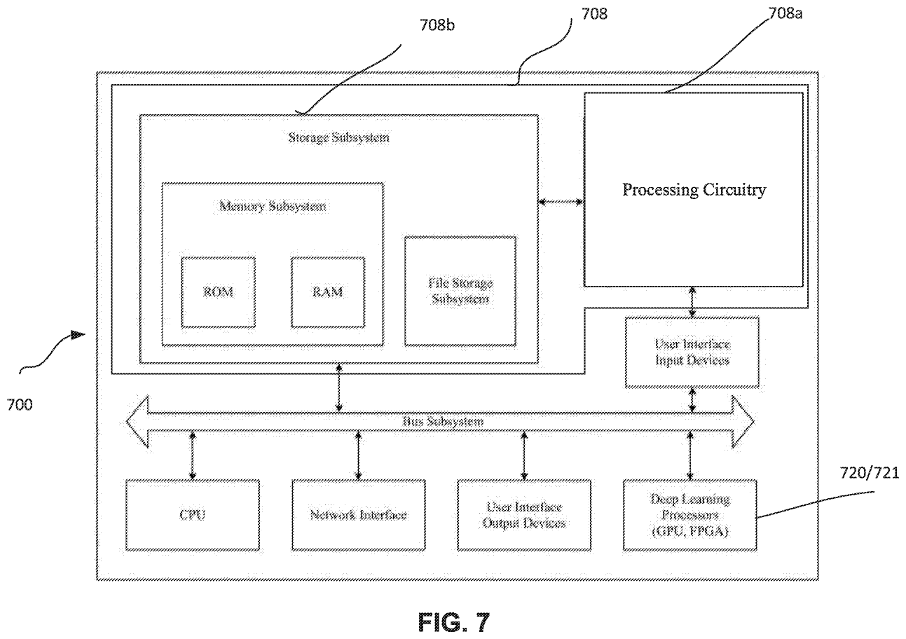

FIG. 7 is a simplified block diagram of a computing platform including a computer system that can be used to implement the technology disclosed. Computer system 700 as shown includes at least one processing circuitry 708a that communicates with a number of peripheral devices via bus subsystem. These peripheral devices can include a storage subsystem 708b including, for example, one or more memory circuitries including, for example, memory devices and a file storage subsystem. All or parts of the processing circuitry 708a and all or parts of the storage subsystem 708b may correspond the processing circuitry 408a and memory 408b of FIG. 4, and computer system 708 may in addition correspond to computer system 408 of FIG. 4, by way of example.

Peripheral devices may further include user interface input devices, user interface output devices, and a network interface subsystem. The input and output devices allow user interaction with computer system. Network interface subsystem provides an interface to outside networks, including an interface to corresponding interface devices in other computer systems.

In one implementation, the neural network-based computing systems according to some embodiments are communicably linked to the storage subsystem and user interface input devices.

User interface input devices can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system.

User interface output devices can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system to the user or to another machine or computer system.

Storage subsystem may store programming and data constructs that provide the functionality of some or all of the methods described herein. These software modules are generally executed by processor alone or in combination with other processors.

The one or more memory circuitries used in the storage subsystem can include a number of memories including a main random access memory (RAM) for storage of instructions and data during program execution and a read only memory (ROM) in which fixed instructions are stored. A file storage subsystem can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem in the storage subsystem, or in other machines accessible by the processing circuitry. The one or more memory circuitries are to store a DKG according to some embodiments.

Bus subsystem provides a mechanism for letting the various components and subsystems of computer system communicate with each other as intended. Although bus subsystem is shown schematically as a single bus, alternative implementations of the bus subsystem can use multiple busses.

Computer system itself can be of varying types including a personal computer, a portable computer, a workstation, a computer terminal, a network computer, a television, a mainframe, a server farm, a widely-distributed set of loosely networked computers, or any other data processing system or user device. Due in part to the ever-changing nature of computers and networks, the description of computer system depicted in FIG. 7 is intended only as a specific example for purposes of illustrating the technology disclosed. Many other configurations of computer system are possible having more or less components than the computer system depicted herein.

The deep learning processors 720/721 can include GPUs, FPGAs, any hardware adapted to perform the computations described herein, or any customized hardware that can optimize the performance of computations as described herein, and can be hosted by a deep learning cloud platforms such as Google Cloud Platform, Xilinx, and Cirrascale. The deep learning processors may include parallel neural network-based computing systems as described above, for example in the context of FIG. 4, such as neural network-based computing systems 420/421.

Examples of deep learning processors include Google's Tensor Processing Unit (TPU), rackmount solutions like GX4 Rackmount Series, GX8 Rackmount Series, NVIDIA DGX-1, Microsoft' Stratix V FPGA, Graphcore's Intelligent Processor Unit (IPU), Qualcomm's Zeroth platform with Snapdragon processors, NVIDIA's Volta, NVIDIA's DRIVE PX, NVIDIA's JETSON TX1/TX2 MODULE, Intel's Nirvana, Movidius VPU, Fujitsu DPI, ARM's DynamicIQ, IBM TrueNorth, and others.

The components of FIG. 7 may be used in the context of any of the embodiments described herein.

The examples set forth herein are illustrative and not exhaustive.

Example 1 includes a computer-implemented method of generating a training model to be used by the neural network-based computing system to process a data set regarding a plurality of semantic concepts, the method including: performing a set of parameterizations of the plurality of semantic concepts, each parameterization of the set including: receiving existing data on the plurality of semantic concepts at an input of a computer system, the computer system including memory circuitry and a processing circuitry coupled to the memory circuitry; generating a data structure using the processing circuitry, the data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and storing the data structure in the memory circuitry; and in response to a determination that an error rate from a processing of the data set by the neural network-based computing system is above a predetermined threshold, performing a subsequent parameterization of the set, and otherwise generating the training model corresponding to the data structure from a last one of the set of parameterizations, the training model to be used by the neural network-based computing system to process further data sets.

Example 2 includes the subject matter of Example 1, and optionally, wherein each MSN corresponds to an intersection of a plurality of dimensions, each activity level in the pattern of activity levels designating a value for a dimension of the plurality of dimensions.

Example 3 includes the subject matter of Example 2, and optionally, further including determining a number of the plurality of dimensions prior to performing the set of parameterizations, wherein the number of the plurality of dimensions is to remain fixed after being determined.

Example 4 includes the subject matter of Example 2, and optionally, wherein the plurality of dimensions includes a dimension representing a trajectory between a semantic concept and one of a prior semantic concept or a subsequent semantic concept in a string of semantic concepts, the method further including incrementing an activity level for the dimension representing the trajectory each time the processing circuitry identifies a string of semantic concepts that invokes the trajectory.

Example 5 includes the subject matter of Example 2, and optionally, further including, after storing the data structure, superimposing data from an additional dimension to the vector space to reconfigure the vector space.

Example 6 includes the subject matter of Example 5, and optionally, wherein superimposing includes superimposing data from an additional dimension to at least one of reconfigure dense regions of the vector space to facilitate a discrimination between closely related semantic concepts, or condense sparse regions of the vector space to facilitate a processing of the data structure.

Example 7 includes the subject matter of Example 2, and optionally, wherein the method includes: in response to a determination that the existing data includes a string of semantic concepts, after storing the data structure, superimposing data from an additional dimension to the vector space to reconfigure the vector space, the additional dimension including a dimension representing a trajectory between a semantic concept and one of a prior semantic concept or a subsequent semantic concept in a string of semantic concepts; and incrementing an activity level for the dimension representing the trajectory each time the processing circuitry identifies a string of semantic concepts that invokes the trajectory.

Example 8 includes the subject matter of Example 2, and optionally, wherein the dimensions correspond to at least two of: a feeling dimension, an action dimension, a place dimension, a people dimension, a time dimension, a space dimension, a person dimension, a communication dimension, a intellect dimension, a social norm dimension, a social interaction dimension, a governance dimension, a setting dimension, a unenclosed area dimension, a sheltered area dimension, a physical impact dimension, a change of location dimension, a high affective arousal dimension, a negative affect valence dimension and or emotion dimension.

Example 9 includes the subject matter of Example 2, and optionally, wherein a dimension of the plurality of dimensions corresponds to a time dimension, and wherein an activity level for the time dimension represents one of time from a linear lunar calendar, time related to an event, time related to a linear scale, time related to a log scale, a non-uniform time scale, or cyclical time.

Example 10 includes the subject matter of Example 2, and optionally, wherein a dimension of the plurality of dimensions corresponds to a space dimension, and wherein an activity level for the space dimension represents one of linear scaled latitude, linear scaled longitude, linear scale altitude, building coordinate codes, allocentric polar coordinates, Global Positioning System (GPS) coordinates, or indoor location WiFi based coordinates.

Example 11 includes the subject matter of Example 1, wand optionally, wherein a degree of similarity between semantic concepts is based on a feature between nodes corresponding thereto in the vector space, the feature including at least one of distance, manifold shapes and trajectories in the vector space.

Example 12 includes the subject matter of Example 1, and optionally, wherein a topology of the vector space represents relationships between semantic concepts.

Example 13 includes the subject matter of Example 1, wand optionally, wherein the neural network-based computing system is coupled to the memory circuitry, the method comprising using the neural network-based computing system to: access the training model in the memory circuitry; and process the data set based on the training model to generate a processed data set.

Example 14 includes the subject matter of Example 13, and optionally, further including using the processed data set as part of the existing data set to perform a subsequent parameterization.

Example 15 includes the subject matter of Example 13, and optionally, wherein processing the data set includes using the data set and the training model to determine at least one of: a most efficient trajectory from one of the nodes to another one of the nodes, nodes located close to a trajectory, a density of trajectories through a node, most likely next nodes, or most likely antecedents to a current node.

Example 16 includes the subject matter of Example 12, and optionally, wherein processing the data set includes using at least one of a gradient descent algorithm, a resistive network analysis algorithm, a diffusive network analysis algorithm, an exhaustive search algorithm or a deep learning algorithm.

Example 17 includes the subject matter of any one of Examples 13-16, and optionally, wherein the neural network-based computing system includes a plurality of neural network-based computing systems each coupled to the memory circuitry, the method including operating the neural network-based computing systems in parallel with one another to simultaneously process the data set based on respective dimensions or respective clusters of dimensions of data of the data set.

Example 18 includes machine-readable medium including code which, when executed, is to cause a machine to perform the method of any one of Examples 1-17.

Example 19 includes a computer system including a memory circuitry and processing circuitry coupled to the memory circuitry, the memory circuitry loaded with instructions, the instructions, when executed by the processing circuitry, to cause the processing circuitry to perform operations comprising: performing a set of parameterizations of a plurality of semantic concepts, each parameterization of the set including: receiving existing data on the plurality of semantic concepts; generating a data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and storing the data structure in the memory circuitry. The operations further include, in response to a determination that an error rate from a processing of a data set by the neural network-based computing system is above a predetermined threshold, performing a subsequent parameterization of the set, and otherwise generating a training model corresponding to the data structure from a last one of the set of parameterizations, a training model to be used by the neural network-based computing system to process further data sets.

Example 20 includes the subject matter of Example 19, and optionally, wherein each MSN corresponds to an intersection of a plurality of dimensions, each activity level in the pattern of activity levels designating a value for a dimension of the plurality of dimensions.

Example 21 includes the subject matter of Example 20, and optionally, the operations further including determining a number of the plurality of dimensions prior to performing the set of parameterizations, wherein the number of the plurality of dimensions is to remain fixed after being determined.

Example 22 includes the subject matter of Example 20, and optionally, wherein the plurality of dimensions includes a dimension representing a trajectory between a semantic concept and one of a prior semantic concept or a subsequent semantic concept in a string of semantic concepts, the operations further including incrementing an activity level for the dimension representing the trajectory each time the processing circuitry identifies a string of semantic concepts that invokes the trajectory.

Example 23 includes the subject matter of Example 20, and optionally, the operations further including, after storing the data structure, superimposing data from an additional dimension to the vector space to reconfigure the vector space.

Example 24 includes the subject matter of Example 23, and optionally, wherein superimposing includes superimposing data from an additional dimension to at least one of reconfigure dense regions of the vector space to facilitate a discrimination between closely related semantic concepts, or condense sparse regions of the vector space to facilitate a processing of the data structure.

Example 25 includes the subject matter of Example 20, and optionally, wherein the operations further include: in response to a determination that the existing data includes a string of semantic concepts, after storing the data structure, superimposing data from an additional dimension to the vector space to reconfigure the vector space, the additional dimension including a dimension representing a trajectory between a semantic concept and one of a prior semantic concept or a subsequent semantic concept in a string of semantic concepts; and incrementing an activity level for the dimension representing the trajectory each time the processing circuitry identifies a string of semantic concepts that invokes the trajectory.

Example 26 includes the subject matter of Example 20, and optionally, wherein the dimensions correspond to at least two of: a feeling dimension, an action dimension, a place dimension, a people dimension, a time dimension, a space dimension, a person dimension, a communication dimension, a intellect dimension, a social norm dimension, a social interaction dimension, a governance dimension, a setting dimension, a unenclosed area dimension, a sheltered area dimension, a physical impact dimension, a change of location dimension, a high affective arousal dimension, a negative affect valence dimension and or emotion dimension.

Example 27 includes the subject matter of Example 20, and optionally, wherein a dimension of the plurality of dimensions corresponds to a time dimension, and wherein an activity level for the time dimension represents one of time from a linear lunar calendar, time related to an event, time related to a linear scale, time related to a log scale, a non-uniform time scale, or cyclical time.

Example 28 includes the subject matter of Example 20, and optionally, wherein a dimension of the plurality of dimensions corresponds to a space dimension, and wherein an activity level for the space dimension represents one of linear scaled latitude, linear scaled longitude, linear scale altitude, building coordinate codes, allocentric polar coordinates, Global Positioning System (GPS) coordinates, or indoor location WiFi based coordinates.

Example 29 includes the subject matter of Example 20, and optionally, wherein a degree of similarity between semantic concepts is based on a feature between nodes corresponding thereto in the vector space, the feature including at least one of distance, manifold shapes and trajectories in the vector space.

Example 30 includes the subject matter of Example 20, and optionally, wherein a topology of the vector space represents relationships between semantic concepts.

Example 31 includes the subject matter of Example 20, and optionally, further including the neural network-based computing system coupled to the memory circuitry, the neural network-based computing system to: access the training model in the memory circuitry; and process the data set based on the training model to generate a processed data set.

Example 32 includes the subject matter of Example 31 wherein the processing circuitry is to use the processed data set as part of the existing data set to perform a subsequent parameterization of the set of parameterizations.

Example 33 includes the subject matter of Example 31, and optionally, wherein processing the data set includes using the data set and the training model to determine at least one of: a most efficient trajectory from one of the nodes to another one of the nodes, nodes located close to a trajectory, a density of trajectories through a node, most likely next nodes, or most likely antecedents to a current node.

Example 34 includes the subject matter of Example 31, and optionally, wherein processing the data set includes using at least one of a gradient descent algorithm, a resistive network analysis algorithm, a diffusive network analysis algorithm, an exhaustive search algorithm or a deep learning algorithm.

Example 35 includes the subject matter of Example 31, and optionally, wherein the neural network-based computing system includes a plurality of neural network-based computing systems each coupled to the memory circuitry, the neural network-based computing systems to operate in parallel with one another to simultaneously process the data set based on respective dimensions or respective clusters of dimensions of data of the data set.

Example 36 includes the subject matter of Example 31, and optionally, wherein the memory circuitries include a random access memory (RAM) to store of instructions and data during program execution, a read only memory (ROM) to store fixed instructions, and a file storage subsystem to persistently store program and data files.

Example 37 includes the subject matter of Example 36, and optionally, further including a peripheral device, and a bus coupling the peripheral device to the processing circuitry.

Example 38 includes a device including: means for performing a set of parameterizations of a plurality of semantic concepts, each parameterization of the set including: means for receiving existing data on the plurality of semantic concepts; means for generating a data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and means for storing the data structure in the memory circuitry. The device further includes means for, in response to a determination that an error rate from a processing of the data set by the neural network-based computing system is above a predetermined threshold, performing a subsequent parameterization of the set; and means for, in response to a determination that an error rate from a processing of the data set by the neural network-based computing system is below a predetermined threshold, generating a training model corresponding to the data structure from a last one of the set of parameterizations, the training model to be used by the neural network-based computing system to process further data sets.

Example 39 includes the subject matter of Example 38, and optionally, wherein each MSN corresponds to an intersection of a plurality of dimensions, each activity level in the pattern of activity levels designating a value for a dimension of the plurality of dimensions.

Example 40 includes the subject matter of Example 39, further including means for operating neural network-based computing systems in parallel with one another to process data on respective dimensions or respective clusters of dimensions of data of the data set simultaneously.

Example 41 includes a machine-readable medium including code which, when executed, is to cause a machine to perform the method of any one of Examples 1-17.

Example 41 includes a product comprising one or more tangible computer-readable non-transitory storage media comprising computer-executable instructions operable to, when executed by at least one computer processor, enable the at least one processor to perform the method of any one of Examples 1-17.

Example 42 includes a method to be performed at a device of a computer system, the method including performing the functionalities of the processing circuitry of any one of the Examples above.

Example 43 includes an apparatus comprising means for causing a device to perform the method of any one of Examples 1-17.

Example 44 includes a training model generated by the method of any one of Examples 1-17.

Example 45 includes data outputs generated by the method of any one of Examples 1-17.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed.

1-25. (canceled)

26. A computer-implemented method of generating a training model to be used by a neural network-based computing system to process a data set regarding a plurality of semantic concepts, the method including:
performing a set of parameterizations of the plurality of semantic concepts, each parameterization of the set including:
receiving existing data on the plurality of semantic concepts at an input of a computer system, the computer system including memory circuitry and a processing circuitry coupled to the memory circuitry;
generating a data structure using the processing circuitry, the data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and
storing the data structure in the memory circuitry; and
in response to a determination that an error rate from a processing of the data set by the neural network-based computing system is above a predetermined threshold, performing a subsequent parameterization of the set, and otherwise generating the training model corresponding to the data structure from a last one of the set of parameterizations, the training model to be used by the neural network-based computing system to process further data sets.

27. The computer-implemented method of claim 26, wherein each MSN corresponds to an intersection of a plurality of dimensions, each activity level in the pattern of activity levels designating a value for a dimension of the plurality of dimensions.

28. The computer-implemented method of claim 27, further including determining a number of the plurality of dimensions prior to performing the set of parameterizations, wherein the number of the plurality of dimensions is to remain fixed after being determined.

29. The computer-implemented method of claim 27, wherein the plurality of dimensions includes a dimension representing a trajectory between a semantic concept and one of a prior semantic concept or a subsequent semantic concept in a string of semantic concepts, the method further including incrementing an activity level for the dimension representing the trajectory each time the processing circuitry identifies a string of semantic concepts that invokes the trajectory.

30. The computer-implemented method of claim 27, further including, after storing the data structure, superimposing data from an additional dimension to the vector space to reconfigure the vector space.

31. The computer-implemented method of claim 30, wherein superimposing includes superimposing data from an additional dimension to at least one of reconfigure dense regions of the vector space to facilitate a discrimination between closely related semantic concepts, or condense sparse regions of the vector space to facilitate a processing of the data structure.

32. The computer-implemented method of claim 27, wherein the method includes:
in response to a determination that the existing data includes a string of semantic concepts, after storing the data structure, superimposing data from an additional dimension to the vector space to reconfigure the vector space, the additional dimension including a dimension representing a trajectory between a semantic concept and one of a prior semantic concept or a subsequent semantic concept in a string of semantic concepts; and
incrementing an activity level for the dimension representing the trajectory each time the processing circuitry identifies a string of semantic concepts that invokes the trajectory.

33. The computer-implemented method of claim 27, wherein a dimension of the plurality of dimensions corresponds to a time dimension, and wherein an activity level for the time dimension represents one of time from a linear lunar calendar, time related to an event, time related to a linear scale, time related to a log scale, a non-uniform time scale, or cyclical time.

34. The computer-implemented method of claim 27, wherein a dimension of the plurality of dimensions corresponds to a space dimension, and wherein an activity level for the space dimension represents one of linear scaled latitude, linear scaled longitude, linear scale altitude, building coordinate codes, allocentric polar coordinates, Global Positioning System (GPS) coordinates, or indoor location WiFi based coordinates.

35. The computer-implemented method of claim 26, wherein a degree of similarity between semantic concepts is based on a feature between nodes corresponding thereto in the vector space, the feature including at least one of distance, manifold shapes and trajectories in the vector space.

36. The computer-implemented method of claim 26, wherein the neural network-based computing system is coupled to the memory circuitry, the method comprising using the neural network-based computing system to:
access the training model in the memory circuitry; and
process the data set based on the training model to generate a processed data set.

37. The computer-implemented method of claim 36, further including using the processed data set as part of the existing data set to perform a subsequent parameterization.

38. The computer-implemented method of claim 36, wherein using the neural network-based computing system to process the data set includes using the data set and the training model to determine at least one of: a most efficient trajectory from one of the nodes to another one of the nodes, nodes located close to a trajectory, a density of trajectories through a node, most likely next nodes, or most likely antecedents to a current node.

39. The computer-implemented method of claim 36, wherein the neural network-based computing system includes a plurality of neural network-based computing systems each coupled to the memory circuitry, the method including operating the neural network-based computing systems in parallel with one another to simultaneously process the data set based on respective dimensions or respective clusters of dimensions of data of the data set.

40. A neural-network-based computer system including a memory circuitry and processing circuitry coupled to the memory circuitry, the memory circuitry loaded with instructions, the instructions, when executed by the processing circuitry, to cause the processing circuitry to perform operations comprising:
performing a set of parameterizations of a plurality of semantic concepts, each parameterization of the set including:
receiving existing data on the plurality of semantic concepts;
generating a data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and
storing the data structure in the memory circuitry; and
in response to a determination that an error rate from a processing of a data set by the neural network-based computing system is above a predetermined threshold, performing a subsequent parameterization of the set, and otherwise generating a training model corresponding to the data structure from a last one of the set of parameterizations, the training model to be used by the neural network-based computing system to process further data sets.

41. The computer system of claim 40, wherein each MSN corresponds to an intersection of a plurality of dimensions, each activity level in the pattern of activity levels designating a value for a dimension of the plurality of dimensions.

42. The computer system of claim 41, wherein the plurality of dimensions includes a dimension representing a trajectory between a semantic concept and one of a prior semantic concept or a subsequent semantic concept in a string of semantic concepts, the operations further including incrementing an activity level for the dimension representing the trajectory each time the processing circuitry identifies a string of semantic concepts that invokes the trajectory.

43. The computer system of claim 41, the operations further including, after storing the data structure, superimposing data from an additional dimension to the vector space to reconfigure the vector space.

44. The computer system of claim 41, wherein the operations include:
in response to a determination that the existing data includes a string of semantic concepts, after storing the data structure, superimposing data from an additional dimension to the vector space to reconfigure the vector space, the additional dimension including a dimension representing a trajectory between a semantic concept and one of a prior semantic concept or a subsequent semantic concept in a string of semantic concepts; and
incrementing an activity level for the dimension representing the trajectory each time the processing circuitry identifies a string of semantic concepts that invokes the trajectory.

45. The computer system of claim 40, wherein the computer system includes the neural network-based computing system, the neural network-based computing system coupled to the memory circuitry and adapted to:
access the training model in the memory circuitry; and
process the data set based on the training model to generate a processed data set.

46. The computer system of claim 45, wherein the neural network-based computing system is to use the data set and the training model to determine at least one of: a most efficient trajectory from one of the nodes to another one of the nodes, nodes located close to a trajectory, a density of trajectories through a node, most likely next nodes, or most likely antecedents to a current node.

47. The computer system of claim 45, wherein the neural network-based computing system includes a plurality of neural network-based computing systems each coupled to the memory circuitry, the neural network-based computing systems to operate in parallel with one another to simultaneously process the data set based on respective dimensions or respective clusters of dimensions of data of the data set.

48. A product comprising one or more tangible computer-readable non-transitory storage media comprising computer-executable instructions operable to, when executed by at least one computer processor of a neural network-based computing system, enable the at least one processor to:
perform a set of parameterizations of a plurality of semantic concepts, each parameterization of the set including:
receiving existing data on the plurality of semantic concepts;
generating a data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and
storing the data structure;
in response to a determination that an error rate from a processing of the data set by the neural network-based computing system is above a predetermined threshold, perform a subsequent parameterization of the set; and
in response to a determination that an error rate from a processing of the data set by the neural network-based computing system is below a predetermined threshold, generate a training model corresponding to the data structure from a last one of the set of parameterizations, the training model to be used by the neural network-based computing system to process further data sets.

49. The product of claim 48, wherein each MSN corresponds to an intersection of a plurality of dimensions, each activity level in the pattern of activity levels designating a value for a dimension of the plurality of dimensions.

50. The product of claim 49, wherein the plurality of dimensions includes a dimension representing a trajectory between a semantic concept and one of a prior semantic concept or a subsequent semantic concept in a string of semantic concepts, the at least one processor further to increment an activity level for the dimension representing the trajectory each time the at least one processor identifies a string of semantic concepts that invokes the trajectory.
